(19) United States
(12) Patent Application Publication
(10) Pub. No.: US 2007/0245843 A1
(43) Pub. Date: Oct. 25, 2007

(54) Rolling element for ball screw unit

(75) Inventors: Wen-Chia Wu, Taichung (TW); Hung-Sung Pan, Taichung (TW)

Correspondence Address: HDSL, 4331 STEVENS BATTLE LANE, FAIRFAX, VA, 22033, US

(73) Assignee: Hiwin Technologies Corp.

(21) Appl. No.: 11/393,807

(22) Filed: Mar. 31, 2006

(51) Int. Cl. F16H 1/24

(52) U.S. Cl. 74/424.81

(57) ABSTRACT

A dexterously designed rolling element for ball screw unit includes a keg-like body formed of an arcuate line revolved about an axis to form an olive shaped body and then intercepted by two parallel planes perpendicular to the axis. Twice of the radius of the curvature of the body is longer than the width between the adjacent crests of the treaded helical track. The distance between the two parallel planes is shorter than the width between the adjacent crests of the threaded helical track so as to increase the contact surface between the rolling element and the helical track, enforce the load carrying capacity of the ball screw unit, and keep the motion of the rolling element smooth.

### BACKGROUND OF THE INVENTION

1. Field of the Invention

The present invention relates to a rolling element for ball screw unit, in particular, a novel rolling element which can serve to substantially increase the contact surface with the helical track in the ball screw unit without enlarging the cavity between the ball screw and the nut proper so as to effectively improve the load carrying capacity of the ball screw unit.

2. Description of the Prior Art

As shown in FIG. 6, a conventional ball screw unit which transmits a mechanical load linearly is essentially composed of a ball screw 2, a nut proper 3, and a plurality of rolling balls 5. The ball screw 2 and the encircling nut proper 3 are coupled together to form a helically threaded slot therebetween so as to serve as a helical track 4 allowing the rolling balls 5 to roll therealong.

The rolling ball 5 is a standardized mechanical component for the ball screw unit, it is characterized in good replaceability, working reliability, less consumption of lubricant, and easy for maintenance. As its static frictional force is not too larger than kinetic one so that it has an excellent starting characteristic well applicable for carrying mechanical load moving at a medium speed.

However, during rolling and slipping in the helical track 4, the rolling ball 5 which is working in the helical track 4 of limited size, will wear out and even crack due to stresses exerted from the rigid helical track 4 and the load it carries thereby shortening its lifespan. In a heavier or speedier working machine, the condition of wearing is worse.

Practically, the rolling ball is a qualified load carrying medium in a working machine with high speed but light load and strict precision. On the contrary, to use a roller is a wise selection for serving in a heavy load. Here, the roller is not well applicable for rolling in a helical track due to its specific structure. An improved structure of a rolling ball is urgently needed for the ball screw unit in all kinds of working condition to serve as a load carrying medium.

The inventor has plunged into this matter for years studying and improving these shortcomings the conventional rolling balls in use, and come up with a novel rolling element as provided in this invention.

### SUMMARY OF THE INVENTION

Accordingly, the present invention is to provide a rolling element for ball screw unit which can serve to substantially increase the contact surface with the helical track in the ball screw nut proper so as to effectively improve the load carrying capacity of the ball screw unit.

The present invention provides a rolling element having a keg-like body formed of an arcuate line revolved about an axis to form an olive shaped body and then intercepted by two parallel planes perpendicular to the axis, and twice of the radius of curvature of the body is larger than the width between the adjacent crests of the threaded helical track so as to increase the contact surface between the rolling element and the helical track and enforce the load carrying capacity of the ball screw unit. Further to this the length between two planar ends of the keg shaped rolling element is shorter than the width between the opposite crests of the helical track to keep the moving of the rolling element smooth.

### BRIEF DESCRIPTION OF THE DRAWINGS

The drawings disclose an illustrative embodiment of the present invention which serves to exemplify the various advantages and objects hereof, and are as follows:

FIG. 1 is a perspective view of the rolling element according to the present invention;

FIG. 2 is a plane view illustrating geometric relation between the rolling element and the helical track according to the present invention;

FIG. 3 is a fractional enlarged view of FIG. 2;

FIG. 4 is a schematic view showing the loaded state of the rolling element according to the present invention;

FIG. 5 is a graphical curve of radius of curvature R (present invention)/ball diameter D2 (prior art) VS load carrying capacity of the rolling element (present invention)/load carrying capacity of the rolling ball (ball of prior art); and

FIG. 6 is a plane view illustrating geometric relation between the rolling ball and the helical track in a conventional ball screw unit.

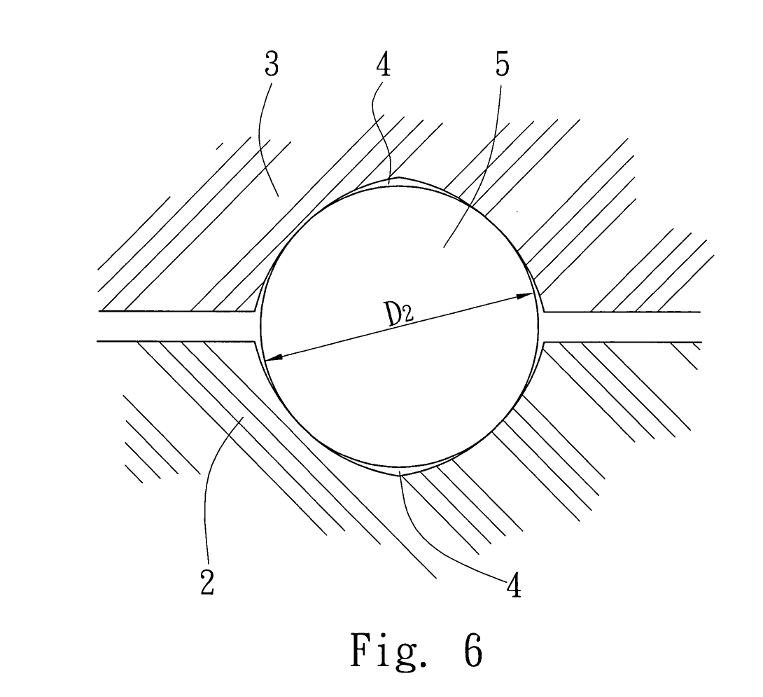

### DETAILED DESCRIPTION OF THE PREFERRED EMBODIMENT

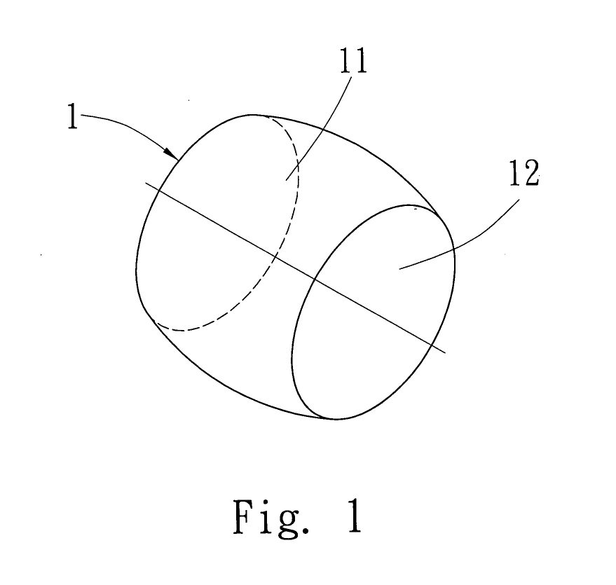

Referring to FIG. 1, in this perspective view of the rolling element according to the present invention, the rolling element 1 is disposed in a helical track 4 with, for example, knuckle threads formed between a ball screw 2 and nut proper 3.

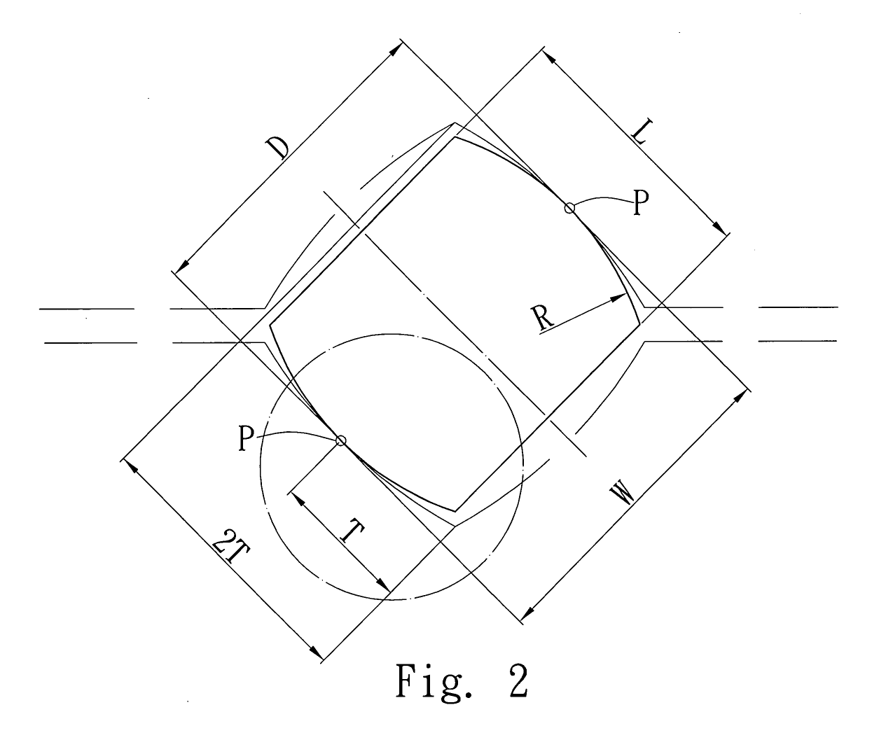

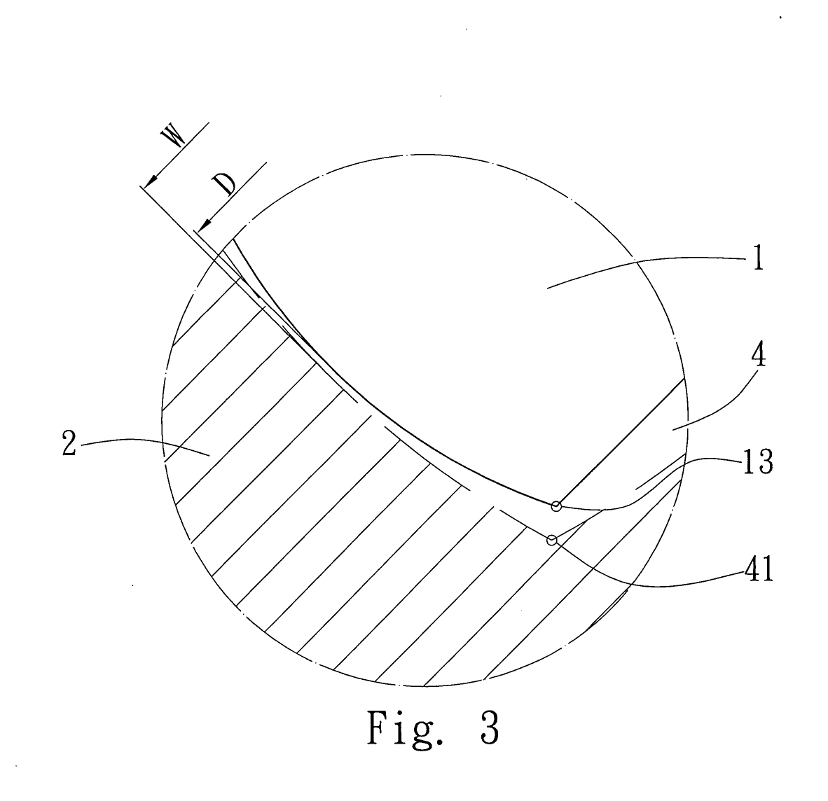

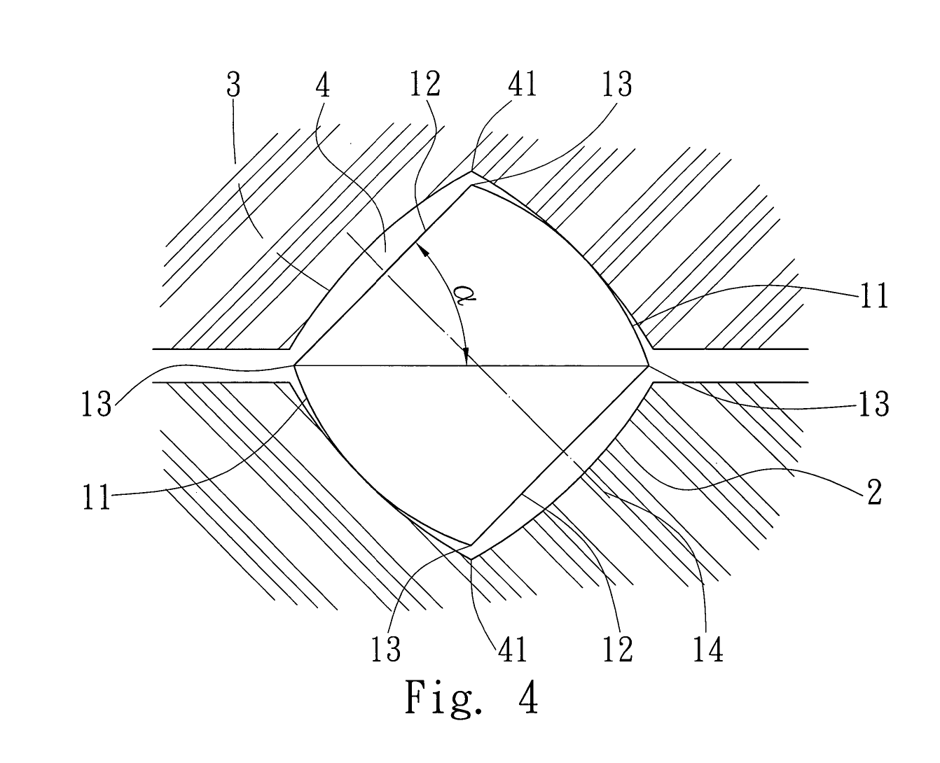

Referring to FIG. 2 through FIG. 4, the kernel of the present invention lies in that the rolling element 1 has a keg-like body formed of an arcuate line revolved about an axis to form an olive shaped body, and then intercepted by two parallel planes 12 perpendicular to that axis. The twice of radius of curvature R of the surface 11 is larger than 0.8 times width W of the helical track 4 along the cross section perpendicular to the helical center, and W is slightly larger than the maximum diameter D of the rolling element 1 so as to increase the contact surface between the rolling element 1 and the helical track 4, and also enforce the load carrying capacity of ball screw 2 and nut proper 3.

Accordingly, as the keg-like rolling element 1 is vertically in contact with the helical track 4, let the contact point P between the arcuate surface of the rolling element 1 and the helical track 4 where the rolling element 1 being exerted by a normal force (see FIG. 2), is apart from the nearest thread crest 41 of the helical track 4 a distance T, then the distance L between the two planes 12 must be made shorter than 2T, wherein T is the shortest distance between crest 41 and P. With this design, the mutual interference between the rolling element 1 and the helical track 4 is substantially avoided to keep the ball screw unit working effectively and smoothly.

It should be understood that the structural design of the rolling element 1 is based on the principles of the applied mechanics. The larger the radii of curvature of two contacted surfaces, the less the stress is exerted on the contact surface. Accordingly, in case the surface of the rolling element 1 contacts the helical track 4 with a larger radius of curvature R, the ball screw 2 and nut proper 3 is capable of enduring heavier load, on the other hand, the maximum stress on the contact surface will be lowered.

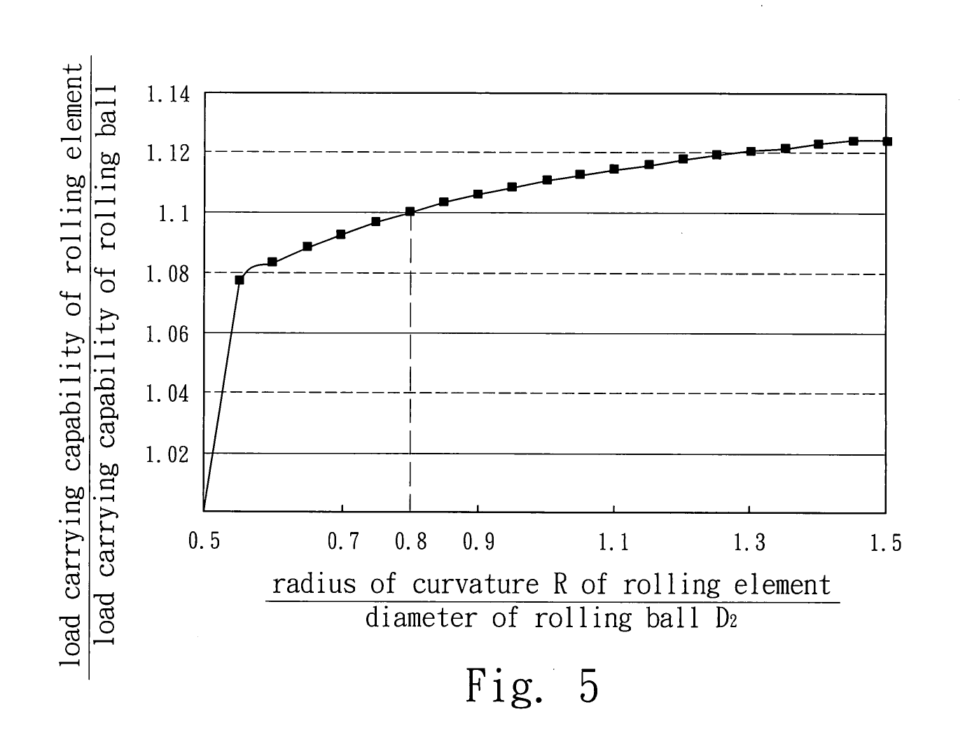

FIG. 5 is a graph showing the relationship between the ratio of the radius of curvature R of the rolling element of the present invention to the traditional rolling ball of diameter D2 to work in the same ball screw unit plotted on the abscissas vs ratio of load carrying capacity of the rolling element of the present invention to the traditional rolling ball plotted on the ordinate in a Cartesian co-ordinate. From the curve plotted in FIG. 5, the load carrying capacity increases as the radius of curvature R of the rolling element 1 increases

Meanwhile, if it is desired to increase load carrying capacity of the rolling element 1 to 1.1 times that of the traditional rolling ball 5, the following formula must be satisfied:
R≧0.8D (1)

In order to prevent the edges formed of the two planes 12 with the keg-like body 11 of the rolling element 1 from obstructing the motion of the rolling element 1 in the helical track 4. The distance L between two planes 12 shall be shorter than the distance 2T between two adjacent crests of the helical track 4 shown in FIG. 2, namely:
2T=(D−2R+\sqrt{(2R+D)²−2D²})/2≧L (2)

Next, In order to avoid collision of edge 13 of the rolling element 1 with the crest 41 of the helical track 4 causing concentrated stress and leading to the mechanical fatigue of the ball screw unit, the acute edge 13 is rounded to a curved surface so as to alleviate impact force by enlarging the contact surface. The principles of applied mechanics teach us: in the case two rigid (for example, steel) objects are in contact with each other forming an arcuate contact surface, the maximum withstanding contact force is obtained in the case the angle α of sector of the contact surface is 30°. For further consideration of safety, the angle α is designed to be 35° in the present invention. In this case the contact angle of the arcuate surface of the rolling element 1 with the surface of the helical track 4 can be calculated from the radius of curvature R of the keg-like body and the distance L between the two planes 12, that is:
L≧0.6R (3)

From formula (1), (2), and (3), it is obvious that the keg-like rolling element 1 disclosed by the present invention is able to carry greater load than the conventional rolling ball.

For conclusion, the rolling element disclosed by the present invention is superior to the conventional rolling ball and roller in all respects, namely:

1. The dexterously designed keg-like structured rolling element greatly improves its load carrying capacity and rigidity which makes it well suited to serve in heavy load machinery with prolonged lifespan of the ball screw unit.

2. The prolonged lifespan of the ball screw unit leads to saving users investment and curtailing maintenance cost.

Although the description above contains many specificities, these should not be construed as limiting the scope of the invention but as merely providing illustration of some of the presently preferred embodiments of this invention. Thus the scope of the invention should be determined by the appended claims and their legal equivalents, rather than, by the examples given.

What is claimed is:

1. A rolling element for a ball screw unit rolling in a helical track formed between a nut proper and a ball screw, the rolling element having a keg-like body formed of an arcuate line revolved about an axis to form an olive shaped body and then intercepted by two parallel planes perpendicular to the axis, and twice of a radius of curvature of the keg-like body being longer than a width between adjacent crests of threaded helical track, and a length between the two parallel planes being shorter than the width between the adjacent crests of the threaded helical track.

2. The rolling element as in claim 1, wherein the radius of curvature R, the length L, a maximum diameter D of the rolling element, and the width 2T satisfy the following relationship:
L≦2T=(D−2R+\sqrt{(2R+D)²−2D²})/2.

3. The rolling element as in claim 2, wherein R and D satisfy the following relationship:
R≧0.8D.

4. The rolling element as in claim 2, wherein L and R satisfy the following relationship:
L≧0.6R.

5. The rolling element as in claim 1, wherein a contact angle of a contact surface between the rolling element and the helical track is larger than 35°.

6. The rolling element as in claim 1, wherein a width of the helical track along a cross section perpendicular to the helical center is approximately equal to the maximum diameter of the rolling element.
